(19) United States
(12) Patent Application Publication
(10) Pub. No.: US 2011/0030891 A1
(43) Pub. Date: Feb. 10, 2011

(54) Lamination process improvement

(75) Inventors: Wenlai Feng, Perrysburg, OH (US); Brian E. Cohen, Perrysburg, OH (US)

Correspondence Address: STEPTOE & JOHNSON LLP, 1330 CONNECTICUT AVENUE, N.W., WASHINGTON, DC, 20036, US

(73) Assignee: First Solar, Inc., Perrysburg, OH (US)

(21) Appl. No.: 12/805,625

(22) Filed: Aug. 10, 2010

Related U.S. Application Data
(60) Provisional application No. 61/232,766, filed on Aug. 10, 2009.

(51) Int. Cl. B29C 65/14

(52) U.S. Cl. 156/272.2; 156/379.6

(57) ABSTRACT

A method of laminating a photovoltaic module may include placing an interlayer in contact with a substrate, heating the interlayer with a source of infrared radiation and pressing the interlayer and the substrate together in a vacuum laminator.

### CLAIM FOR PRIORITY

This application claims priority under 35 U.S.C. §119(e) to U.S. Provisional Patent Application Ser. No. 61/232,766 filed on Aug. 10, 2009, which is hereby incorporated by reference.

### TECHNICAL FIELD

The present invention relates to photovoltaic modules and methods of production.

### BACKGROUND

Photovoltaic modules can include semiconductor material deposited over a substrate, for example, with a first layer serving as a window layer and a second layer serving as an absorber layer. The semiconductor window layer can allow the penetration of solar radiation to the absorber layer, such as a cadmium telluride layer, which converts solar energy to electricity. Photovoltaic module can also contain one or more transparent conductive oxide layers, which are also often conductors of electrical charge.

### DESCRIPTION OF DRAWINGS

FIG. 1 is a schematic of a photovoltaic module.

FIG. 2 is a schematic of a photovoltaic module.

FIG. 3 is a schematic of a photovoltaic module.

FIG. 4 is a schematic of a system for laminating a photovoltaic module.

FIG. 5 is a schematic of a system for laminating a photovoltaic module.

FIG. 6 is a schematic of a system for laminating a photovoltaic module.

### DETAILED DESCRIPTION

A photovoltaic module can include a transparent conductive oxide layer adjacent to a substrate and layers of semiconductor material. The layers of semiconductor material can include a bi-layer, which may include an n-type semiconductor window layer, and a p-type semiconductor absorber layer. The n-type window layer and the p-type absorber layer may be positioned in contact with one another to create an electric field. Photons can free electron-hole pairs upon making contact with the n-type window layer, sending electrons to the n side and holes to the p side. Electrons can flow back to the p side via an external current path. The resulting electron flow provides current, which combined with the resulting voltage from the electric field, creates power. The result is the conversion of photon energy into electric power. To preserve and enhance device performance, numerous layers can be positioned above the substrate in addition to the semiconductor window and absorber layers.

Photovoltaic modules can be formed on optically transparent substrates, such as glass. Because glass is not conductive, a transparent conductive oxide (TCO) layer is typically deposited between the substrate and the semiconductor bi-layer. Cadmium stannate functions well in this capacity, as it exhibits high optical transmission and low electrical sheet resistance. A smooth buffer layer can be deposited between the TCO layer and the semiconductor window layer to decrease the likelihood of irregularities occurring during the formation of the semiconductor window layer. Additionally, a barrier layer can be incorporated between the substrate and the TCO layer to lessen diffusion of sodium or other contaminants from the substrate to the semiconductor layers, which could result in degradation and delamination. The barrier layer can be transparent, thermally stable, with a reduced number of pin holes and having high sodium-blocking capability, and good adhesive properties. Therefore the TCO can be part of a three-layer stack, which may include, for example, a silicon dioxide barrier layer, a cadmium stannate TCO layer, and a buffer layer (e.g., a tin (IV) oxide). The buffer layer can include various suitable materials, including tin oxide, zinc tin oxide, zinc oxide, and zinc magnesium oxide. A photovoltaic module can include a cadmium sulfide window layer deposited over a TCO stack and a cadmium telluride absorber layer deposited over the cadmium sulfide layer. Cadmium telluride photovoltaic modules offer several advantages over other photovoltaic technologies. Among those are superior light absorption properties under cloudy and diffuse light conditions and ease of manufacturing.

The cadmium telluride thin film layer can be encapsulated within the module by materials designed to seal and hold the module together for many years and under a variety of conditions. The encapsulation material can help retain heavy metals present within the module by forming low solubility compounds that immobilize, chelate, adsorb, and/or fixate the cadmium and/or other heavy metals within the structure of the module to assist with handling and disposal.

In one aspect, a method for laminating a photovoltaic module can include placing an interlayer in contact with a substrate, heating the interlayer and the substrate with a source of infrared radiation, and pressing the interlayer and the substrate together.

The method can include various optional features. For example, the substrate can include glass. The glass can be soda lime glass. Pressing the interlayer and the substrate together can include using a vacuum laminator. The interlayer can be placed in contact with the substrate before heating the interlayer and the substrate with a source of infrared radiation takes place. The interlayer can be placed in contact with the substrate after heating the interlayer and the substrate with a source of infrared radiation takes place. Heating of the interlayer and the substrate with a source of infrared radiation can take place both before and after the interlayer is placed in contact with the substrate. The interlayer can include a thermoplastic interlayer. The thermoplastic interlayer can include an acrylonitrile butadiene styrene (ABS), an acrylic (PMMA), a celluloid, a cellulose acetate, a cycloolefin copolymer (COC), a polyvinyl butyral (PVB), a silicone, an epoxy, an ethylene vinyl acetate (EVA), an ethylene vinyl alcohol (EVOH), a fluoroplastic (PTFE), an ionomer, KYDEX®, a liquid crystal polymer (LCP), a polyacetal (POM), a polyacrylate, a polyacrylonitrile (PAN), a polyamide (PA), a polyamide-imide (PAI), a polyaryletherketone (PAEK), a polybutadiene (PBD), a polybutylene (PB), a polybutylene terephthalate (PBT), a polycaprolactone (PCL), a polychlorotrifluoroethylene (PCTFE), a polyethylene terephthalate (PET), a polycyclohexylene dimethylene terephthalate (PCT), a polycarbonate (PC), a polyhydroxyalkanoate (PHA), a polyketone (PK), a polyester, a polyethylene (PE), a polyetheretherketone (PEEK), a polyetherketoneketone (PEKK), a polyetherimide (PEI), a polyethersulfone (PES), a polyethylenechlorinate (PEC), a polyimide (PI), a polylactic acid (PLA), a polymethylpentene (PMP), a polyphenylene oxide (PPO), a polyphenylene sulfide (PPS), a polyphthalamide (PPA), a polypropylene (PP), a polystyrene (PS), a polysulfone (PSU), a polytrimethylene terephthalate (PTT), a polyurethane (PU), a polyvinyl acetate (PVA), a polyvinyl chloride (PVC), a polyvinylidene chloride (PVDC), or a styrene-acrylonitrile (SAN), or any other suitable material, or any combination thereof. In certain embodiments, the thermoplastic interlayer can include an ethylene vinyl acetate (EVA), a polyvinyl butyral (PVB), a silicone, or an epoxy.

In certain embodiments, the method can include heating the interlayer and the substrate with a source of infrared radiation to take place before pressing the interlayer and the substrate together. In certain embodiments, the method can include heating the interlayer and the substrate with a source of infrared radiation to take place after pressing the interlayer and the substrate together. In certain embodiments, the method can include heating the interlayer and the substrate with a source of infrared radiation to take place before and after pressing the interlayer and the substrate together. The method can further include subjecting the interlayer and the substrate to at least one nip roll. In certain embodiments, the method can include subjecting the interlayer and the substrate to at least one nip roll before pressing the interlayer and the substrate together. In certain embodiments, the method can include subjecting the interlayer and the substrate to at least one nip roll after pressing the interlayer and the substrate together. The method can include subjecting the layers of the substrate to at least one nip roll before and after pressing the interlayer and the substrate together. In certain embodiments, the method can include subjecting the interlayer and the substrate to at least one nip roll before heating the interlayer and the substrate with a source of infrared radiation. In certain embodiments, the method can include subjecting the interlayer and the substrate to at least one nip roll after heating the interlayer and the substrate with a source of infrared radiation. In certain embodiments, the method can include subjecting the interlayer and the substrate to at least one nip roll before and after heating the interlayer and the substrate with a source of infrared radiation. In certain embodiments, the method can include heating the interlayer and the substrate with a source of infrared radiation to take place before and after subjecting the interlayers and the substrate to at least one nip roll. The method can include any combination of heating the interlayer and the substrate with a source of infrared radiation, pressing the interlayer and the substrate together and subjecting the interlayer and the substrate to at least on nip roll.

In another aspect, a system for laminating a photovoltaic module may include an IR heater configured to heat an interlayer in contact with a substrate, and a press configured to force the interlayer and the substrate together.

The system may include various optional features. For example, the substrate can include glass. The glass can be soda lime glass. A press configured to force the interlayer and the substrate together can include a vacuum laminator. The interlayer can be placed in contact with the substrate before an IR heater configured to heat the interlayer and the substrate is used. The interlayer can be placed in contact with the substrate after an IR heater configured to heat the interlayer and the substrate is used. An IR heater configured to heat the interlayer and the substrate can be used both before and after the interlayer is placed in contact with the substrate. The interlayer can include a thermoplastic interlayer. The thermoplastic interlayer can include an acrylonitrile butadiene styrene (ABS), an acrylic (PMMA), a celluloid, a cellulose acetate, a cycloolefin copolymer (COC), a polyvinyl butyral (PVB), a silicone, an epoxy, an ethylene vinyl acetate (EVA), an ethylene vinyl alcohol (EVOH), a fluoroplastic (PTFE), an ionomer, KYDEX®, a liquid crystal polymer (LCP), a polyacetal (POM), a polyacrylate, a polyacrylonitrile (PAN), a polyamide (PA), a polyamide-imide (PAI), a polyaryletherketone (PAEK), a polybutadiene (PBD), a polybutylene (PB), a polybutylene terephthalate (PBT), a polycaprolactone (PCL), a polychlorotrifluoroethylene (PCTFE), a polyethylene terephthalate (PET), a polycyclohexylene dimethylene terephthalate (PCT), a polycarbonate (PC), a polyhydroxyalkanoate (PHA), a polyketone (PK), a polyester, a polyethylene (PE), a polyetheretherketone (PEEK), a polyetherketoneketone (PEKK), a polyetherimide (PEI), a polyethersulfone (PES), a polyethylenechlorinate (PEC), a polyimide (PI), a polylactic acid (PLA), a polymethylpentene (PMP), a polyphenylene oxide (PPO), a polyphenylene sulfide (PPS), a polyphthalamide (PPA), a polypropylene (PP), a polystyrene (PS), a polysulfone (PSU), a polytrimethylene terephthalate (PTT), a polyurethane (PU), a polyvinyl acetate (PVA), a polyvinyl chloride (PVC), a polyvinylidene chloride (PVDC), or a styrene-acrylonitrile (SAN), or any other suitable material, or any combination thereof. In certain embodiments, the thermoplastic interlayer can include an ethylene vinyl acetate (EVA), a polyvinyl butyral (PVB), a silicone, or an epoxy.

In certain embodiments, the system can include using an IR heater configured to heat the interlayer before the interlayer contacts the substrate. In certain embodiments, the system can include using an IR heater configured to heat the interlayer after the interlayer contacts the substrate. In certain embodiments, the system can include using an IR heater configured to heat the interlayer before and after the interlayer contacts the substrate. In certain embodiments, the system can include at least one nip roll to treat the interlayer and the substrate configured to force the interlayer and the substrate together before the press. In certain embodiments, the system can include at least one nip roll to treat the interlayer and the substrate configured to force the interlayer and the substrate together after the press. In certain embodiments, the system can include at least one nip roll to treat the interlayer and the substrate configured to force the interlayer and the substrate together before and after the press. In certain embodiments, the system can include at least one nip roll to treat the interlayer and the substrate configured to force the interlayer and the substrate together before the IR heater. In certain embodiments, the system can include at least one nip roll to treat the interlayer and the substrate configured to force the interlayer and the substrate together after the IR heater. In certain embodiments, the system can include at least one nip roll to treat the interlayer and the substrate configured to force the interlayer and the substrate together before and after the IR heater. In certain embodiments, the system can include the IR heater before and after at least one nip roll to treat the interlayer and the substrate configured to force the interlayer and the substrate together. The system can include any combination of an IR heater configured to heat the interlayer in contact with the substrate, a press configured to force the interlayer and the substrate together and at least on nip roll to treat the interlayer and the substrate configured to force the interlayer and the substrate together.

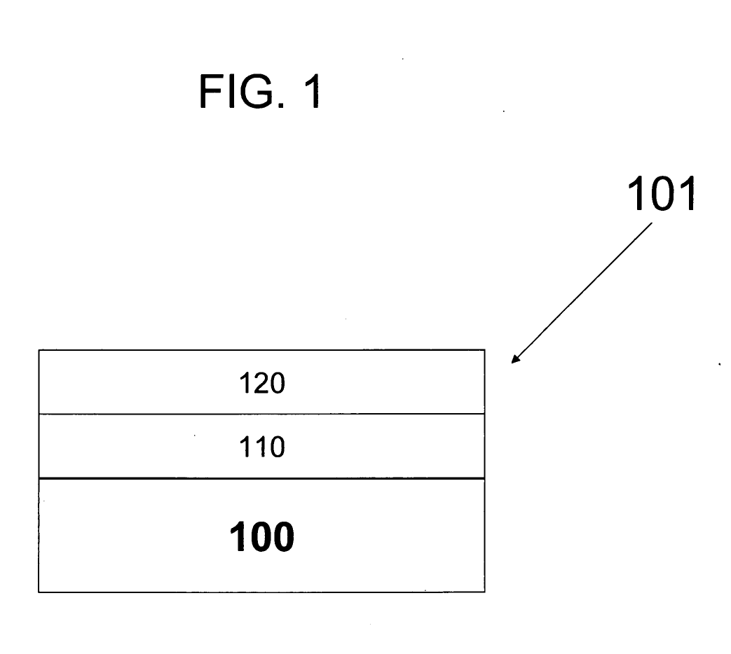

Referring to FIG. 1, a self-remediating photovoltaic module 101 can include a front substrate 100. Front substrate 100 can include any suitable material, including glass, for example, soda-lime glass. One or more layers 110 can be deposited adjacent to front substrate 100, which can serve as a first substrate, on top of which various layers may be added. Layer(s) 110 can include one or more device layers. For example, layer(s) 110 can include a cadmium telluride absorber layer adjacent to a cadmium sulfide window layer. Layer (s) 110 can include additional metal layers adjacent to the cadmium telluride absorber layer. One or more metal immobilizing agents can be deposited adjacent to layer(s) 110. For example, a metal immobilizing agent 120 can be deposited adjacent to layer(s) 110.

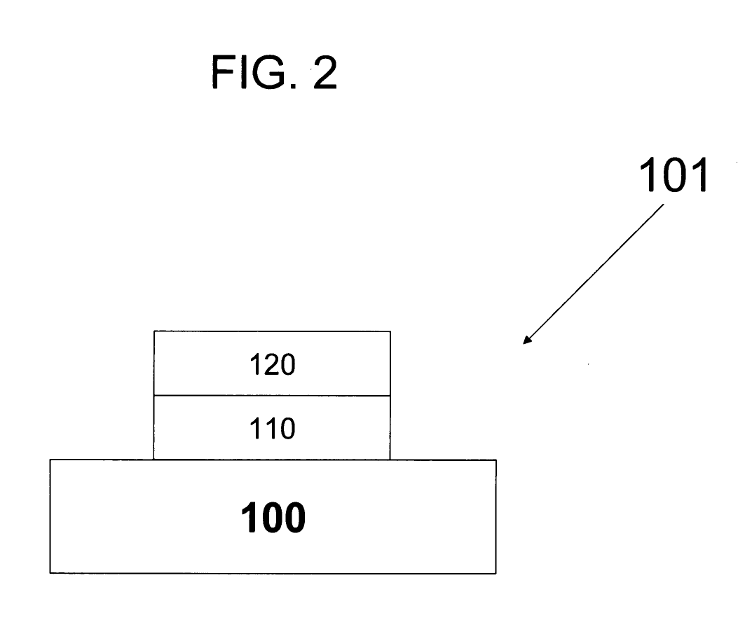

Portions of semiconductor material and other coatings can be deleted from the edges of photovoltaic modules, which may comprise a series of connected photovoltaic devices. For example, industry requirements dictate that photovoltaic modules maintain a minimum non-conductive width around their perimeters. Traditional methods of deleting coating from photovoltaic modules have required the use of mechanical brushes. Though adequate for removing unwanted material, brushes have a tendency to wear, causing a number of problems, including non-uniformity in the coating-removal process, downtime for maintenance, and recurring replacement costs. An alternative is to forgo the use of mechanical brushes altogether and to remove the undesired material optically using laser scribing. Because photovoltaic modules may contain glass substrates, lasers are capable of penetrating the photovoltaic structure through the substrate layer to remove the unwanted coatings on the other side. Referring to FIG. 2, portions of layer(s) 110 and layer(s) 120 have been removed from photovoltaic device 101 by mechanical means that can include laser scribing.

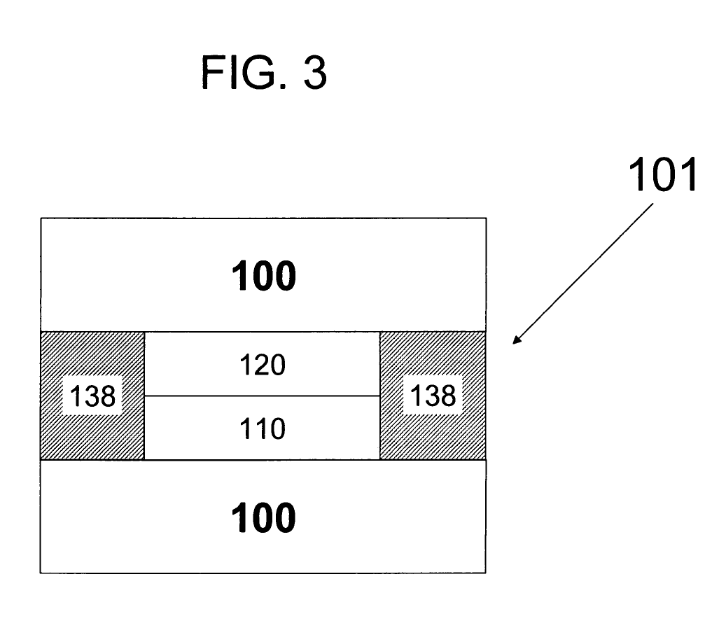

Referring to FIG. 3, photovoltaic module 101 can include one or more interlayers 138, in contact with layer(s) 110 and layer(s) 120. A photovoltaic module 101 can also include a back substrate 130. Back substrate 130 can include any suitable material, including glass, for example, soda-lime glass. Back substrate 130 can be added to photovoltaic module 101 after the addition of interlayers 138. Alternately, back substrate 130 can be added to photovoltaic module 101 before interlayers 138 are added.

The layers of photovoltaic module 101 can be aligned, heated, and bonded together by a lamination process. Lamination encapsulates the semiconductor layers, TCO, metal conductor, and any other layers of photovoltaic module 101, sealing the photovoltaic devices from the environment. The front substrate 100 and the back substrate 130 can be bonded together with interlayers 138 through a lamination process. The interlayers can include a thermoplastic interlayer. The thermoplastic interlayer can include an acrylonitrile butadiene styrene (ABS), an acrylic (PMMA), a celluloid, a cellulose acetate, a cycloolefin copolymer (COC), a polyvinyl butyral (PVB), a silicone, an epoxy, an ethylene-vinyl acetate (EVA), an ethylene vinyl alcohol (EVOH), a fluoroplastic (PTFE), an ionomer, KYDEX®, a liquid crystal polymer (LCP), a polyacetal (POM), a polyacrylate, a polyacrylonitrile (PAN), a polyamide (PA), a polyamide-imide (PAI), a polyaryletherketone (PAEK), a polybutadiene (PBD), a polybutylene (PB), a polybutylene terephthalate (PBT), a polycaprolactone (PCL), a polychlorotrifluoroethylene (PCTFE), a polyethylene terephthalate (PET), a polycyclohexylene dimethylene terephthalate (PCT), a polycarbonate (PC), a polyhydroxyalkanoate (PHA), a polyketone (PK), a polyester, polyethylene (PE), a polyetheretherketone (PEEK), a polyetherketoneketone (PEKK), a polyetherimide (PEI), a polyethersulfone (PES), a polyethylenechlorinate (PEC), a polyimide (PI), a polylactic acid (PLA), a polymethylpentene (PMP), a polyphenylene oxide (PPO), a polyphenylene sulfide (PPS), a polyphthalamide (PPA), a polypropylene (PP), a polystyrene (PS), a polysulfone (PSU), a polytrimethylene terephthalate (PTT), a polyurethane (PU), a polyvinyl acetate (PVA), a polyvinyl chloride (PVC), a polyvinylidene chloride (PVDC), or a styrene-acrylonitrile (SAN), or any other suitable material, or any combination thereof. In certain embodiments, thermoplastic interlayer can include an ethylene vinyl acetate (EVA), a polyvinyl butyral (PVB), a silicone, or an epoxy.

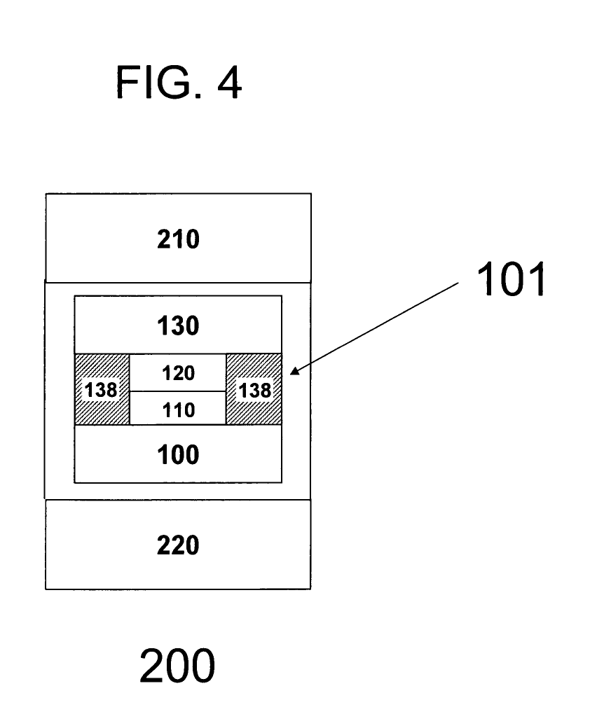

Referring to FIG. 4, front substrate 100, back substrate 130 and interlayer 138 of photovoltaic module 101 can be pressed together. The means of pressing front substrate 100, back substrate 130 and interlayer 138 can include a vacuum laminator. A vacuum laminator treats the photovoltaic module in a vacuum chamber by heating from the bottom heating plate 220 of the vacuum laminator that is facing back substrate 130 while the top and bottom plates 210 and 220 of the vacuum laminator press front substrate 100 and back substrate 130 together. Interlayer 138 can be melted, allowed to flow and fill in gaps, and cured by this process.

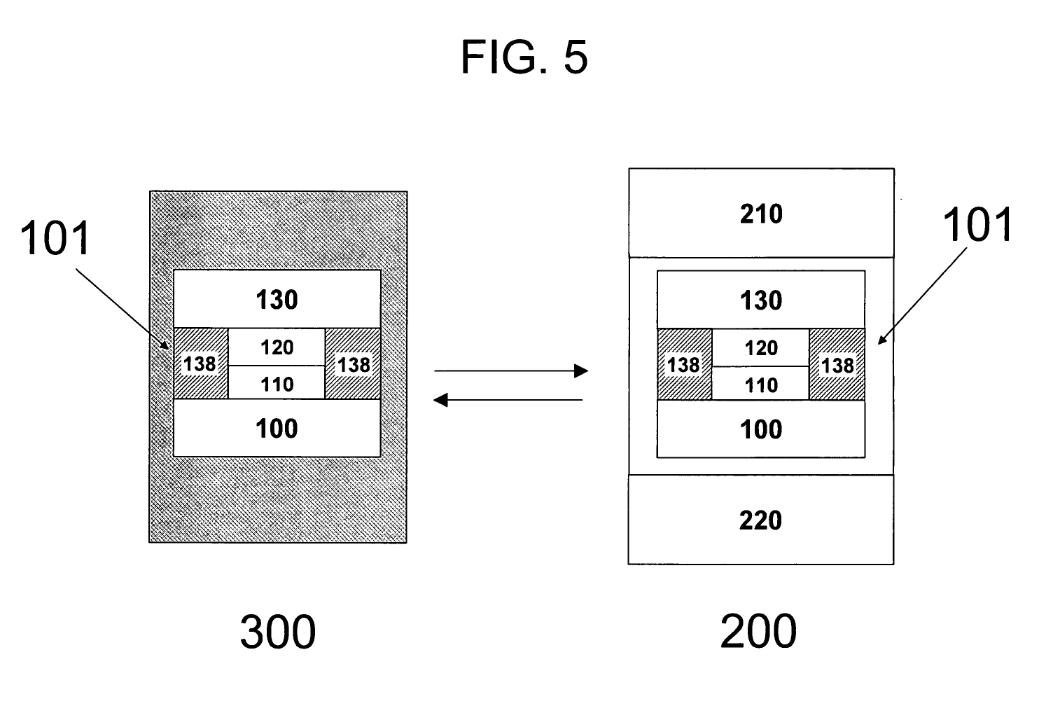

Referring to FIG. 5, photovoltaic module 101 can be heated with a source of infrared radiation (IR) 300 in addition to treatment in vacuum laminator 200 in the lamination process. An IR heater 300 can be used before interlayer 138 is added to photovoltaic device 101. An IR heater 300 can be used after interlayer 138 is added to photovoltaic device 101. An IR heater 300 can be used before and after interlayer 138 is added to photovoltaic device 101. An IR heater 300 can be used before treatment of photovoltaic module 101 in vacuum laminator 200 to preheat the photovoltaic module. An IR heater 300 can be used after treatment of photovoltaic module 101 in laminator 200 for continuous heating and curing of the interlayer of the photovoltaic module. An IR heater 300 can be used both before and after treatment of photovoltaic module 101 in laminator 200 for preheating of the module and continuous heating and curing of the interlayer. An IR heater 300 can be used more than once during the lamination of photovoltaic module 101.

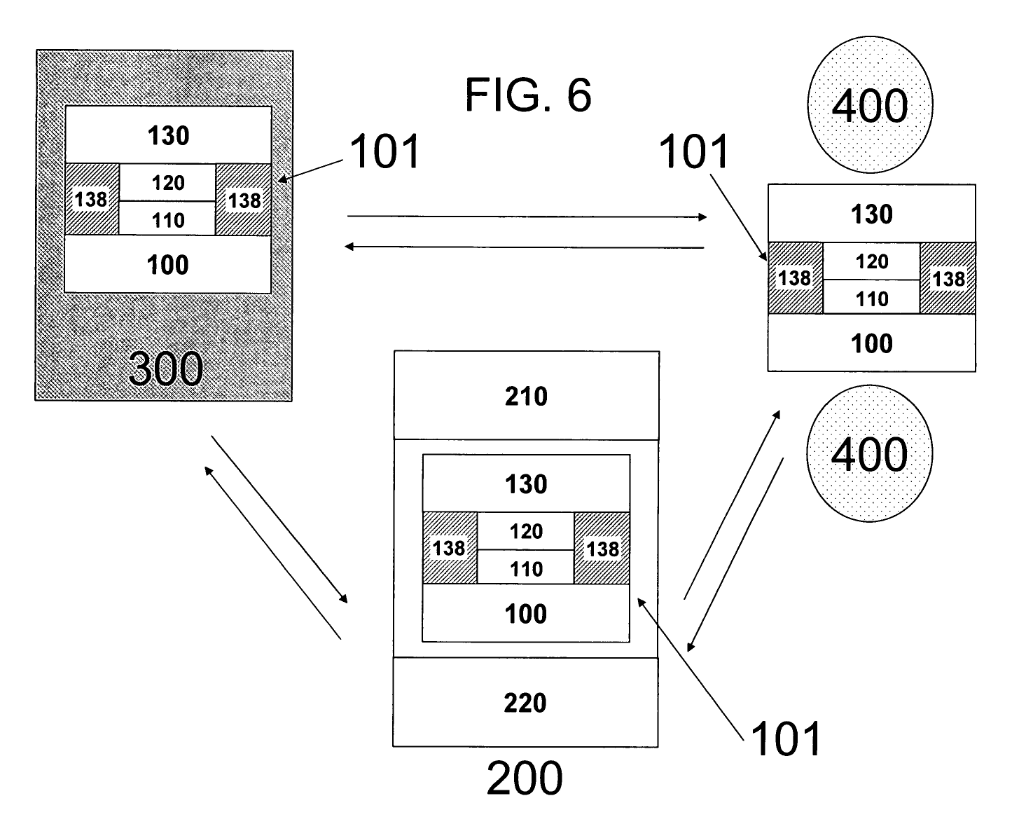

Referring to FIG. 6, photovoltaic module 101 can be subjected to at least one nip roll 400 configured to force the interlayer and the substrate together in addition to an IR heater 300 and treatment of photovoltaic module 101 in vacuum laminator 200. A nip roll 400 can be used before treatment of photovoltaic module 101 in vacuum laminator 200 to de-air photovoltaic module 101. A nip roll 400 can be used after treatment of photovoltaic module 101 in vacuum laminator 200 to put pressure on photovoltaic module 101 and to improve the flow of interlayers 138. A nip roll 400 can be used both before and after treatment of photovoltaic module 101 in vacuum laminator 200 to de-air photovoltaic module 101 and to put pressure on photovoltaic module 101 and to improve the flow of interlayers 138. A nip roll 400 can also be used before, after or both before and after IR heater 300. IR heater 300 can be used before, after or both before and after a nip roll 400. A nip roll 400 can be used more than once during lamination of photovoltaic module 101. Nip roll(s), IR heater(s) and treatment in a vacuum laminator can be used in any possible combination and permutation for the lamination of a photovoltaic module.

Photovoltaic modules fabricated using the methods discussed herein may be incorporated into one or more photovoltaic arrays. The arrays may be incorporated into various systems for generating electricity. For example, a photovoltaic module may be illuminated with a beam of light to generate a photocurrent. The photocurrent may be collected and converted from direct current (DC) to alternating current (AC) and distributed to a power grid. Light of any suitable wavelength may be directed at the module to produce the photocurrent, including, for example, more than 400 nm, or less than 700 nm (e.g., ultraviolet light). Photocurrent generated from one photovoltaic module may be combined with photocurrent generated from other photovoltaic modules. For example, the photovoltaic modules may be part of a photovoltaic array, from which the aggregate current may be harnessed and distributed.

The embodiments described above are offered by way of illustration and example. It should be understood that the examples provided above may be altered in certain respects and still remain within the scope of the claims. It should be appreciated that, while the invention has been described with reference to the above preferred embodiments, other embodiments are within the scope of the claims.

What is claimed is:

1. A method for laminating a photovoltaic module, the method comprising:
placing an interlayer in contact with a substrate;
heating the interlayer and the substrate with a source of infrared radiation; and
pressing the interlayer and the substrate together.

2. The method of claim 1, wherein the substrate comprises glass.

3. The method of claim 1, wherein pressing the interlayers and the substrate together includes using a vacuum laminator.

4. The method of claim 1, wherein placing the interlayer in contact with a substrate takes place before heating the interlayer and the substrate with a source of infrared radiation.

5. The method of claim 1, wherein placing the interlayer in contact with a substrate takes place after heating the interlayer and the substrate with a source of infrared radiation.

6. The method of claim 1, wherein heating the interlayer and the substrate with a source of infrared radiation takes place before and after placing the interlayer in contact with the substrate.

7. The method of claim 1, wherein the interlayer includes a thermoplastic interlayer.

8. The method of claim 8, wherein the thermoplastic interlayer includes an acrylonitrile butadiene styrene, an acrylic, celluloid, a cellulose acetate, a cycloolefin copolymer, a polyvinyl butyral, a silicone, an epoxy, an ethylene vinyl acetate, an ethylene vinyl alcohol, a fluoroplastic, an ionomer, KYDEX®, a liquid crystal polymer, a polyacetal, a polyacrylate, a polyacrylonitrile, a polyamide, a polyamide-imide, a polyaryletherketone, a polybutadiene, a polybutylene, a polybutylene terephthalate, a polycaprolactone, a polychlorotrifluoroethylene, a polyethylene terephthalate, a polycyclohexylene dimethylene terephthalate, a polycarbonate, a polyhydroxyalkanoate, a polyketone, a polyester, a polyethylene, polyetheretherketone, a polyetherketoneketone, a polyetherimide, a polyethersulfone, a polyethylenechlorinate, a polyimide, a polylactic acid, a polymethylpentene, a polyphenylene oxide, a polyphenylene sulfide, a polyphthalamide, a polypropylene, a polystyrene, a polysulfone, a polytrimethylene terephthalate, a polyurethane, a polyvinyl acetate, a polyvinyl chloride, a polyvinylidene chloride, or a styrene-acrylonitrile, or any combination thereof.

9. The method of claim 9, wherein the thermoplastic interlayer includes an ethylene vinyl acetate, a polyvinyl butyral, a silicone, or an epoxy.

10. The method of claim 1, wherein heating the interlayer and the substrate with a source of infrared radiation takes place before pressing the interlayer and the substrate together.

11. The method of claim 1, wherein heating the interlayer and the substrate with a source of infrared radiation takes place after pressing the interlayer and the substrate together.

12. The method of claim 1, wherein heating the interlayer and the substrate with a source of infrared radiation takes place before and after pressing the interlayer and the substrate together.

13. The method of claim 1, further comprising subjecting the interlayer and a substrate to at least one nip roll.

14. The method of claim 14, wherein subjecting the interlayer and a substrate to at least one nip roll takes place before pressing the interlayer and the substrate together.

15. The method of claim 14, wherein subjecting the interlayer and a substrate to at least one nip roll takes place after pressing the interlayer and the substrate together.

16. The method of claim 14, wherein subjecting the interlayer and a substrate to at least one nip roll takes place before and after pressing the interlayer and the substrate together.

17. The method of claim 14, wherein subjecting the interlayer and a substrate to at least one nip roll takes place before heating the interlayer and the substrate with a source of infrared radiation.

18. The method of claim 14, wherein subjecting the interlayer and a substrate to at least one nip roll takes place after heating the interlayer and the substrate with a source of infrared radiation.

19. The method of claim 14, wherein subjecting the interlayer and a substrate to at least one nip roll takes place before and after heating the interlayer and the substrate with a source of infrared radiation.

20. The method of claim 14, wherein heating the interlayer and the substrate with a source of infrared radiation takes place before and after subjecting the interlayer and the substrate to at least one nip roll.

21. A system of laminating a photovoltaic module comprising:
an interlayer in contact with a substrate;
an IR heater configured to heat an interlayer in contact with a substrate; and
a press configured to force the interlayer and the substrate together.

22. The system of claim 22, wherein the press includes a vacuum laminator.

23. The system of claim 22, wherein the IR heater is configured to heat the interlayer before the interlayer contacts the substrate.

24. The system of claim 22, wherein the IR heater is configured to heat the interlayer after the interlayer contacts the substrate.

25. The system of claim 22, the IR heater is configured to heat the interlayer before and after the interlayer contacts the substrate.

26. The system of claim 22, wherein the interlayer includes a thermoplastic interlayer.

27. The system of claim 22, wherein the IR heater configured to heat the interlayer in contact with the substrate is used before the press configured to force the interlayer and the substrate together is used.

28. The system of claim 22, wherein the IR heater configured to heat the interlayer in contact with the substrate is used after the press configured to force the interlayer and the substrate together is used.

29. The system of claim 22, wherein the IR heater configured to heat the interlayer in contact with the substrate is used before and after the press configured to force the interlayer and the substrate together is used.

30. The system of claim 22, further comprising at least one nip roll to treat the interlayer and the substrate.

31. The system of claim 35, wherein at least one nip roll to treat the interlayer and the substrate is configured to force the interlayer and the substrate together before the press.

32. The system of claim 35, wherein at least one nip roll to treat the interlayer and the substrate is configured to force the interlayer and the substrate together after the press.

33. The system of claim 35, wherein at least one nip roll to treat the interlayer and the substrate is configured to force the interlayer and the substrate together before and after the press.

34. The system of claim 35, wherein at least one nip roll to treat the interlayer and the substrate is configured to force the interlayer and the substrate together before the IR heater.

35. The system of claim 35, wherein at least one nip roll to treat the interlayer and the substrate is configured to force the interlayer and the substrate together after the IR heater.

36. The system of claim 35, wherein at least one nip roll to treat the interlayer and the substrate is configured to force the interlayer and the substrate together before and after the IR heater.
